(19) United States
(12) Patent Application Publication
(10) Pub. No.: US 2026/0360601 A1
(43) Pub. Date: Nov. 12, 2026

(54) MAGNETIC CLIP

(71) Applicant: Dzine Products, LLC, Addison, IL (US)

(72) Inventors: Nicholas Lullo, Addison, IL (US); Mitchell R. Martin, Addison, IL (US)

(21) Appl. No.: 19/203,305

(22) Filed: May 9, 2025

(51) Int. Cl. H01F 7/02; F16M 11/04; F16M 11/10; G03B 17/56; H04R 1/02

(52) U.S. Cl. CPC H01F 7/0263; F16M 11/041; F16M 11/10; G03B 17/561; H04R 1/026

(57) ABSTRACT

A magnetic clip comprising a first element including first and second magnets separated by a first distance, and a second element including third and fourth magnets separated by a second distance equivalent to the first distance. The arrangement enables the first and second elements to be slidably disposed with respect to each other while maintaining magnetic attraction. The magnetic clip includes an alignment element, such as a track with raised sides and a lip, that maintains axial alignment of the elements during sliding movement. The magnetic clip provides an adjustable, secure connection for various applications including electronic device mounting interfaces.

### CROSS-REFERENCE TO RELATED APPLICATION

This application does not claim priority to any earlier filed applications.

### FIELD

The present invention relates generally to fastening devices, and more particularly to magnetic fastening mechanisms that provide secure, adjustable engagement while maintaining alignment.

### BACKGROUND

Magnetic fastening devices are widely used in various applications, including securing papers, clothing, and other objects. Traditional magnetic clips typically rely on a single pair of magnets or a single magnetic element and a ferromagnetic counterpart to hold objects together. While effective in many cases, these devices often lack adjustability and the ability to maintain consistent alignment between the fastening elements. In situations where precise alignment and the ability to adjust the relative positions of the elements are important, conventional magnetic clips fall short in providing the necessary functionality.

Additionally, many existing magnetic clips do not adequately address the need for a secure yet easily adjustable fastening mechanism. For instance, in some devices, the magnetic force can cause the elements to misalign or separate when subjected to movement or external forces. Other devices may use mechanical parts that complicate the clip's structure, adding bulk and reducing its ease of use.

### SUMMARY

The present invention relates to a magnetic clip comprising two elements, each containing two magnets. The magnets in each element are separated by an equal distance, allowing the two elements to be slidably disposed with respect to each other. This magnetic clip offers an alignment mechanism that allows the elements to maintain a consistent spatial relationship while being adjustable. The clip further includes features such as an alignment element, which ensures axial alignment of the elements, a track structure to facilitate sliding motion, and specific arrangements of the magnets to enhance magnetic attraction and functionality.

In one embodiment, the magnetic clip includes a first element with a first magnet and a second magnet separated by a first distance, and a second element with a third magnet and a fourth magnet separated by a second distance. The first distance is equivalent to the second distance, enabling the elements to be slidably disposed with respect to each other while maintaining magnetic attraction.

The first element can include a track with a flat base and raised opposing sides, forming an alignment element that maintains axial alignment of the first and second elements during sliding movement. The track may include a lip on a portion of each of the raised opposing sides, with the lip extending over the track to provide additional constraint on the movement of the second element.

The magnetic clip may be configured for use with electronic devices, such as radio or camera interfaces, where precise alignment and secure attachment are critical.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a magnetic clip showing first and second clip elements;

FIG. 2 is a perspective view of the magnetic clip of FIG. 1 in an indexed position showing the relationship between the two elements;

FIG. 3 is a perspective view of the magnetic clip of FIGS. 1 and 2 with the elements fully engaged;

FIG. 4 is a series of perspective views showing the assembly sequence (from right to left) for a magnetic radio interface implementation of the magnetic clip;

FIG. 5 is a perspective view of a radio interface configuration; and

FIG. 6 is a series of perspective views showing a magnetic camera interface implementation of the magnetic clip in various stages of engagement.

### DETAILED DESCRIPTION

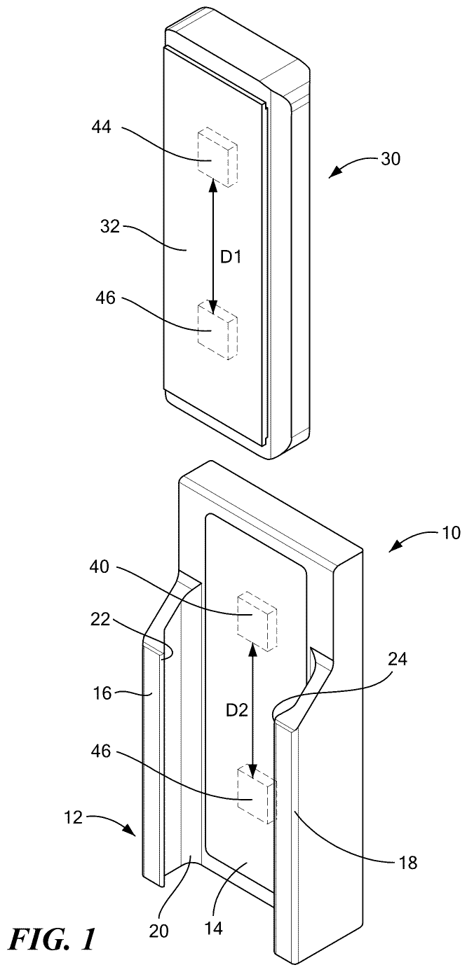

Referring to FIG. 1, a magnetic clip includes a first element 10 and a second element 30. Each element includes a pair of magnets (40 and 42 in first element 10 and 44 and 46 in second element 30) that are contained with the respective element, with the magnets in the first element (first magnet 40 and second magnet 42) being separated by a first distance d1, and the magnets in the second element (third magnet 44 and fourth magnet 46) being separated by a second distance d2. The first distance d1 is equivalent to the second distance d2, ensuring uniformity in the clip's magnetic field distribution and enabling the two elements 10, 30 to be slidably disposed in relation to each other. The magnets can be embedded within the first and second elements or mounted so that a portion of the magnets are flush with a surface of the elements.

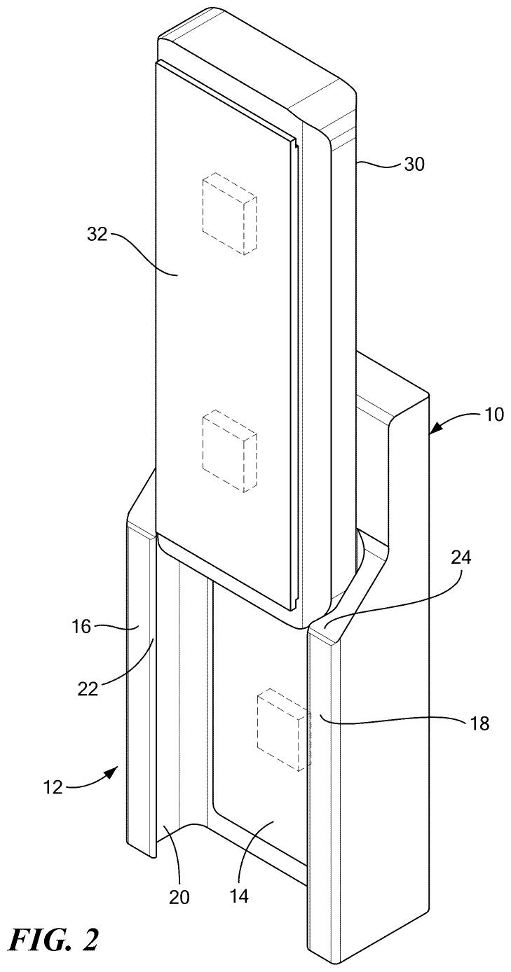

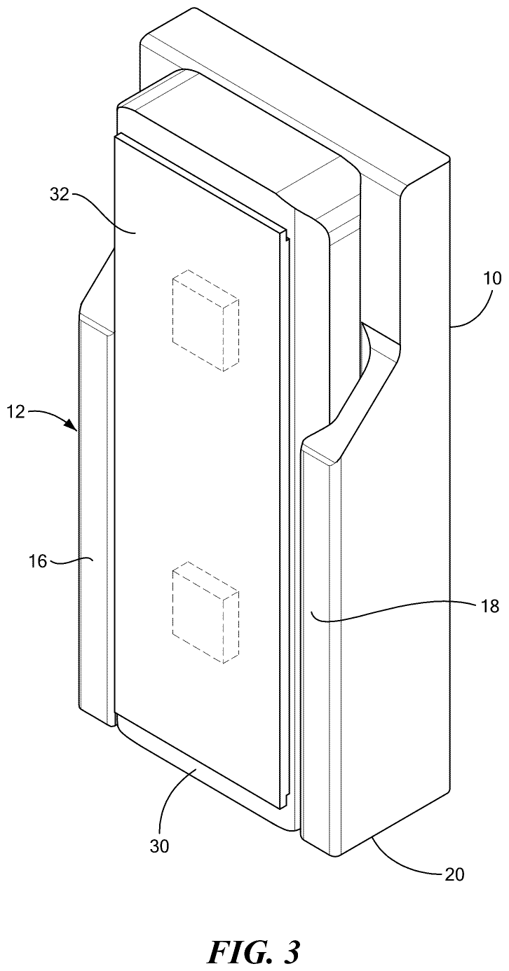

The first element 10 and the second element 30 remain in contact while being slidably disposed. This contact can be facilitated through a variety of mechanisms, including frictional engagement, an alignment system such as a track 12, or other structural features that allow the elements to move smoothly in a controlled manner. FIG. 1 shows the second element 30 aligned with the track 12 of the first element. FIG. 2 shows the second element 30 entering the track 12 of the first element 10; and FIG. 3 shows the second element 30 fully received within the track 12 of the first element 10.

The alignment system 12 is included to maintain axial alignment of the first and second elements 10, 30. This alignment element 12 may take the form of a track defined within the first element 10. The track 12 can include a flat base 20 and raised opposing sides 16, 18, guiding the second element 30 as it slides relative to the first element 10. This structure ensures that the sliding motion remains linear and prevents any unintended lateral displacement of the elements.

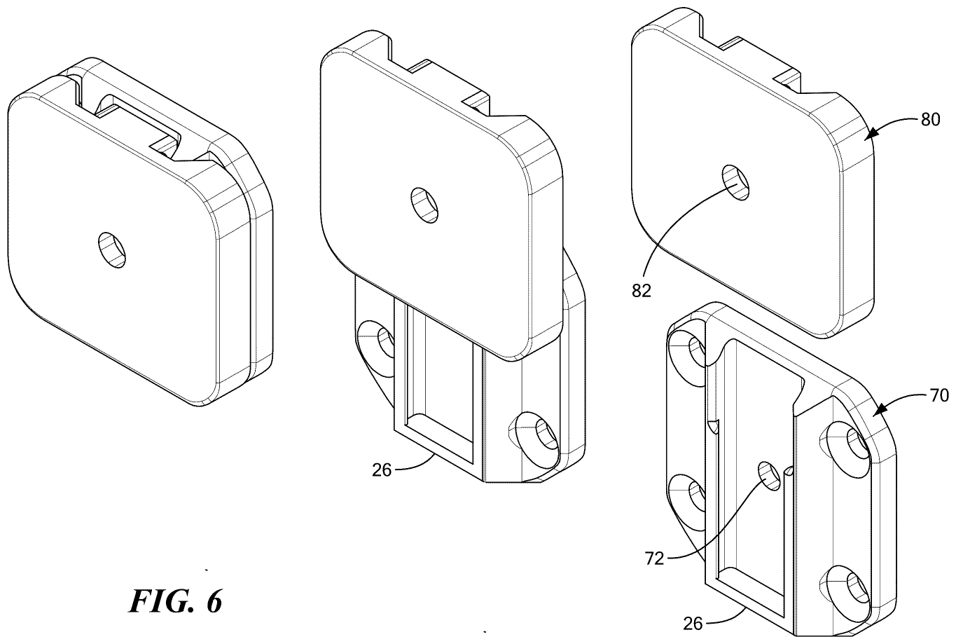

The track 12 may further include a lip 22, 24 on a portion of each of the raised opposing sides 16, 18. The lip 22, 24 extends over the track 12, thereby providing an additional constraint on the movement of the second element 30, ensuring that it stays within the track 12 during sliding. Additionally, the track 12 may be closed at one end 26 as shown in FIG. 6 to limit the range of sliding motion, preventing the two elements 10, 30 from separating entirely during use.

As shown, the first and second magnets 40, 42 of the first element 10 are arranged to be coplanar, and similarly, the third and fourth magnets 44, 46 of the second element 30 are coplanar. This arrangement enhances the magnetic field interaction between the elements, as the coplanar magnets ensure a consistent attraction or repulsion force across the entire surface area where the elements are in contact. Furthermore, the first, second, third, and fourth magnets 40, 42, 44, 46 are positioned along a longitudinal axis (L) of the magnetic clip, contributing to a balanced and uniform magnetic field distribution.

The magnets within the magnetic clip possess specific polarities that enhance the clip's functionality. The first and second magnets 40, 42 in the first element 10 have a first polarity, while the third and fourth magnets 44, 46 in the second element 30 have a second polarity. This polarity arrangement ensures that the first and second magnets 40, 42 are magnetically attracted to the third and fourth magnets 44, 46, thus holding the two elements together. The magnetic attraction between these elements provides the clip with a strong holding force while still allowing the elements to slide relative to each other as needed.

Referring to FIG. 1, a perspective view of a first embodiment of the magnetic clip is shown in a mount side configuration. The first element 10 includes a housing with an embedded track structure 12 visible along its length. The dark area 14 represents the location of one or more magnets embedded within the housing. The track structure 12 includes raised opposing sides 16, 18 and a flat base 20.

FIG. 2 illustrates the magnetic clip in an indexed position, showing the relationship between the first element 10 and the second element 30. The second element 30 is partially engaged with the first element 10, demonstrating the slidable nature of their connection while maintaining magnetic attraction. The second element 30 includes a main body portion 32 with embedded magnets 34, 36 represented by the dark area. The first element can be provided with attachment features such as screw holes, clips, bands or adhesives to secure it to an object like a vehicle dashboard. The second element can be provided with similar attachment elements suitable for temporary or permanent fixation to a portable device, such as a phone, radio, tool, etc.

As shown in FIG. 3, when the elements 10, 30 are fully engaged together, they form a unified structure while still allowing for adjustable positioning. The track mechanism 12 ensures proper alignment throughout the range of motion. Lips 22, 24 extend from the raised opposing sides 16, 18 over the track 12 to provide additional constraint on the movement of the second element 30.

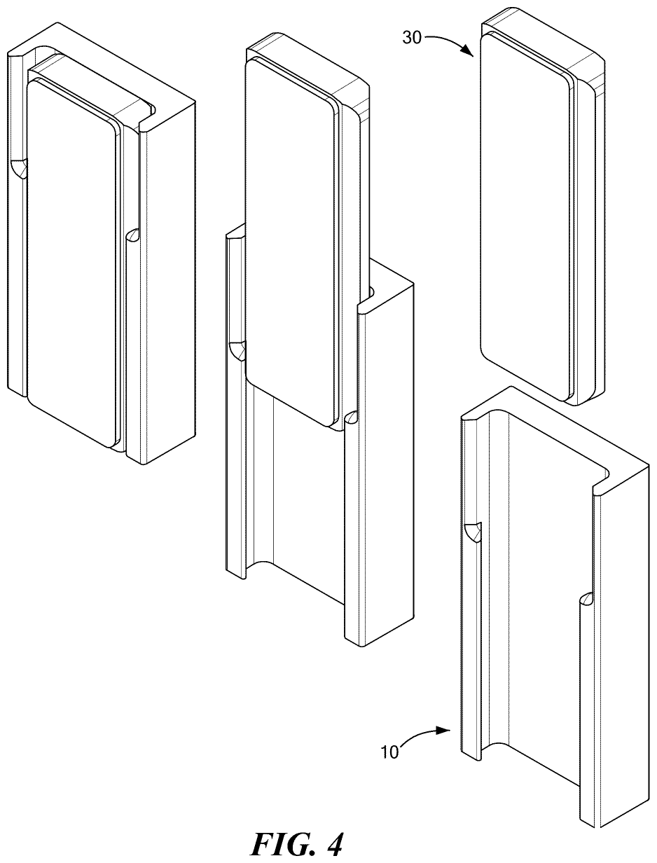

FIG. 4 provides an exploded view of the magnetic clip, clearly showing the separate first element 10 and second element 30. Each element contains embedded magnets as described above that work together to create the secure, adjustable connection. The first element 10 contains first and second magnets 40, 42 separated by a first distance d1, while the second element 30 contains third and fourth magnets 44, 46 separated by a second distance d2 equivalent to the first distance d1.

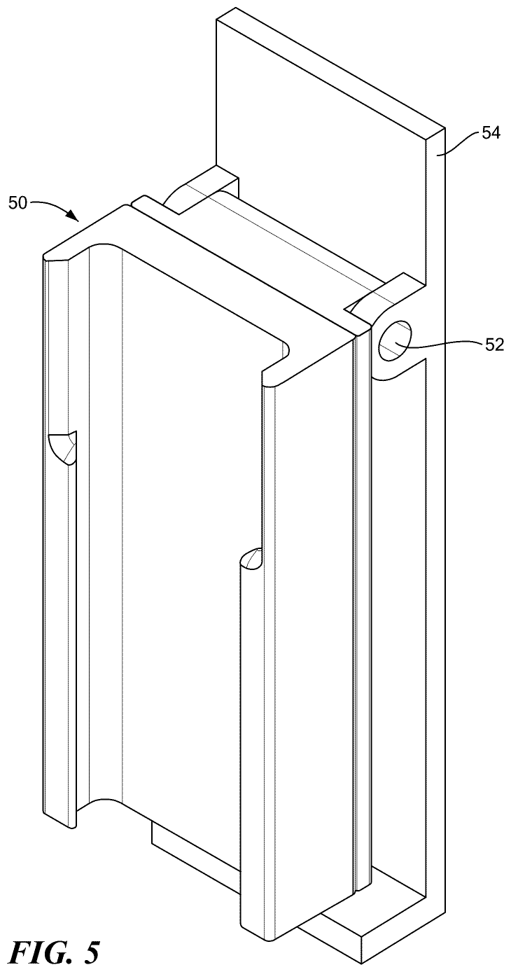

FIG. 5 illustrates a specific implementation of the magnetic clip as a radio interface. As shown, a magnetic clip 50 in accordance with the invention is hinge mounted at a pivot point 52 to a secondary mounting element 54.

FIG. 6 illustrates another application of the magnetic clip as a camera interface. This series of images shows the two elements 70, 80 in various stages of engagement, demonstrating the versatility of the invention for different applications requiring secure but adjustable magnetic connections. The first element 70 includes camera mounting features 72 and embedded magnets as described above, while the second element 80 includes complementary mounting features 82 and corresponding magnets.

The magnetic clip can be adapted for use with electronic devices, specifically radio and camera equipment, as well as battery packs, tool belts or anything that benefits from a secure mounting mechanism that allows for precise positioning and easy adjustment without sacrificing stability. The track system ensures that the connected devices maintain proper alignment throughout adjustment.

The magnetic clip of the present invention offers several advantages over conventional magnetic fastening devices. The dual-magnet arrangement in each element provides a more balanced and consistent magnetic field, enhancing the holding power while still allowing for smooth adjustment. The track mechanism ensures that the elements remain properly aligned during movement, addressing a common issue with traditional magnetic clips that tend to misalign when adjusted.

Additionally, the magnetic clip can be adapted for various applications beyond those specifically illustrated. For example, the clip could be used for securing documents, clothing fasteners, packaging closures, or as mounting mechanisms for various devices. The basic principles of the dual-magnet arrangement and track alignment system remain consistent across these applications, with specific dimensions and configurations adapted to suit the particular use case.

Overall, the magnetic clip offers a versatile and reliable solution for applications requiring a secure yet adjustable magnetic fastening mechanism. The detailed arrangement of the magnets, alignment elements, and track features provide a robust structure that maintains alignment and ensures consistent performance.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A magnetic clip, comprising:
a first element including a first magnet and a second magnet, the first and second magnets being separated by a first distance; and
a second element including a third magnet and a fourth magnet, the third and fourth magnets being separated by a second distance, wherein the first distance is equivalent to the second distance and wherein the first element and the second element are slidably disposed with respect to each other.

2. The magnetic clip of claim 1, wherein the first element and the second element are in contact with each other while being slidably disposed.

3. The magnetic clip of claim 1, further including an alignment element that holds the first element in axial alignment with the second element.

4. The magnetic clip of claim 3, wherein the alignment element defines a track in the first element.

5. The magnetic clip of claim 4, wherein the track includes a flat base and raised opposing sides.

6. The magnetic clip of claim 5, further comprising a lip on a portion of each of the raised opposing sides, and wherein the lip extends over the track.

7. The magnetic clip of claim 5, wherein the track is closed on one end.

8. The magnetic clip of claim 1, wherein the first magnet is coplanar with the second magnet.

9. The magnetic clip of claim 8, wherein the third magnet is coplanar with the fourth magnet.

10. The magnetic clip of claim 9, wherein the first element and the second element include a longitudinal axis and wherein the first, second, third and fourth magnets are located along the longitudinal axis.

11. The magnetic clip of claim 10, wherein the first and second magnets have a first polarity.

12. The magnetic clip of claim 11, wherein the third and fourth magnets have a second polarity, such that the first magnet and the second magnet are attracted to the third and the fourth magnet.

13. The magnetic clip of claim 1, wherein the first element and the second element form a mounting interface for an electronic device.

14. The magnetic clip of claim 1, wherein the first and second elements are configured to maintain magnetic attraction throughout their range of slidable movement.

15. The magnetic clip of claim 1, wherein the first element includes limiting features that restrict the range of slidable movement of the second element.

16. The magnetic clip of claim 3, wherein the alignment element includes at least one projecting feature on the first element and a corresponding receiving feature on the second element.

17. The magnetic clip of claim 1, wherein the first and second elements are formed from a combination of magnetic and non-magnetic materials.

18. A method of using the magnetic clip of claim 1, comprising:
attaching the first element to a first object;
attaching the second element to a second object;
bringing the first and second elements into magnetic engagement; and
adjusting the relative position of the first and second elements by sliding them with respect to each other while maintaining magnetic engagement.
